(19) United States
(12) Patent Application Publication
(10) Pub. No.: US 2016/0031242 A1
(43) Pub. Date: Feb. 4, 2016

(54) PRINTER

(71) Applicant: Funai Electric Co., Ltd., Osaka (JP)

(72) Inventor: Yutaka SASAKI, Sakai-shi (JP)

(21) Appl. No.: 14/810,562

(22) Filed: Jul. 28, 2015

(30) Foreign Application Priority Data
Jul. 29, 2014 (JP) 2014-154310

(51) Int. Cl. B41J 29/377

(52) U.S. Cl. CPC B41J 29/377

(57) ABSTRACT

A printer includes a carriage that is reciprocatable, and including a print head from which ink is ejected to a medium, a rotating body that rotates in a first direction, and a second direction opposite to the first direction, in accordance with reciprocation of the carriage, and a fan that rotates in the first direction by contact with a portion of the rotating body when the rotating body rotates in the first direction.

### BACKGROUND OF THE INVENTION

1. Field of the Invention

The present invention relates to a printer which ejects ink toward a medium to perform printing on the recording medium.

2. Description of the Related Art

An inkjet printer is known as an example of a printer for performing printing. The inkjet printer prints an image on a recording medium by ejecting ink from nozzles of print heads toward the recording medium. During ejection of ink, a carriage carrying the print heads reciprocates in a direction crossing a conveyance direction of the recording medium substantially at right angles.

A conventional inkjet printer contains a printed circuit board therein, on which electric circuits are disposed, for example. In this case, the printed circuit board generates heat in accordance with operation of the printer, in which condition electronic components provided on the printed circuit board may be damaged. One of the possible solutions to this problem is to use highly heat-resistant parts for constituting the electronic components provided on the printed circuit board. In this case, however, costs may increase.

Accordingly, as a solution to this problem, a cooling fan has been provided on the conventional inkjet printer (for example, see JP 2005-86494 A). This fan rotates only in one direction to discharge heated gas to the outside of the inkjet printer. The rotation of the fan during operation (printing) of the inkjet printer supplies airflow to the printed circuit board to cool the printed circuit board.

However, the conventional inkjet printer uses a clutch system which includes a plurality of gears for rotating the fan in one direction. The clutch system adopted by the conventional inkjet printer increases the number of parts contained in the inkjet printer. As a result, size reduction of the inkjet printer is difficult to achieve.

### SUMMARY OF THE INVENTION

Preferred embodiments of the present invention provide a printer capable of preventing heating and causing damage to components of the printer while achieving size reduction of the printer.

A printer according to one aspect of various preferred embodiments of the present invention includes a carriage that includes a print head from which ink is ejected to a medium; a rotating body that rotates in a first direction based on movement of the carriage; and a fan that rotates in the first direction by contacting with a portion of the rotating body when the rotating body rotates in the first direction.

According to this aspect, the rotating body is rotated by a driving force of a motor to drive the carriage. The rotating body rotates in the first direction when the motor that reciprocates the carriage rotates in the first direction. In this case, the fan rotates in the first direction by contact with a portion of the rotating body, in which condition airflow is moved from the fan toward the front of the fan. When the rotation direction of the motor that reciprocates the carriage subsequently changes to the second direction opposite to the first direction, the fan still continues rotation by an inertia force in the same direction as the rotation direction of the fan at the time of rotation of the motor in the first direction. As a result, airflow is continued to be moved from the fan toward the front of the fan. In this case, the moved air flows from the fan toward the front of the fan in accordance with rotation of the motor that reciprocates the carriage in either direction of the first direction or the second direction. Accordingly, air heated by heat generated within a housing of the printer is dischargeable to the outside of the housing such that thermal damage to components is prevented.

For example, in the printer according to the one aspect of various preferred embodiments of the present invention, the rotating body may include a first protrusion that protrudes from a circumference of the rotating body toward the fan in a radial direction of the rotating body. In this case, the fan may include a second protrusion that protrudes toward the rotating body to engage with the first protrusion at the time of rotation of the rotating body in the first direction.

According to this aspect, the fan is rotatable by contact, more specifically, by engagement between the first protrusion protruding from the circumference of the rotating body toward the fan in the radial direction of the rotating body, and the second protrusion provided on the fan, at the time of rotation of the rotating body in the first direction.

For example, the printer according to the one aspect of various preferred embodiments of the present invention may adopt a configuration wherein the fan includes a blade assembly, and a base rotatable with the blade assembly; the rotating body has a hollow and cylindrical shape; the base has a cylindrical shape; and the rotating body surrounds a circumference of the base.

According to this aspect, the center of the blade assembly preferably is positioned on a rotation axis of the rotating body. Accordingly, rotation of the blade assembly becomes stable.

For example, the printer according to the one aspect of various preferred embodiments of the present invention may adopt a configuration wherein the fan includes a blade assembly, and a base rotatable with the blade assembly; a portion of the base has a hollow and cylindrical shape; the rotating body has a cylindrical shape; and the base surrounds the circumference of the rotating body.

According to this aspect, the blade assembly of the fan is able to be disposed on the base in a stable manner even when the blade assembly of the fan is large in size. Accordingly, rotation of the blade assembly becomes stable.

For example, in the printer according to the one aspect of various preferred embodiments of the present invention, one of the first protrusion and the second protrusion may escape from the other of the first protrusion and the second protrusion without engagement between the first protrusion and the second protrusion when the rotating body rotates in the second direction opposite to the first direction.

According to this aspect, the blade assembly is rotatable in one direction, in which condition, unidirectional airflow is produced. Accordingly, efficient cooling of the printer is achieved.

For example, in the printer according to the one aspect of various preferred embodiments of the present invention, the one of the first protrusion and the second protrusion may include a surface brought into contact with the other of the first protrusion and the second protrusion when the rotating body rotates in the second direction. In this case, the surface may be inclined relative to a surface from which the one of the first protrusion and the second protrusion protrudes, in such an inclination direction as not to interrupt an action of the other of the first protrusion and the second protrusion.

According to this aspect, the first protrusion and the second protrusion are easily brought into engagement with each other. In this case, the blade assembly is easily rotatable in one direction. Accordingly, unidirectional airflow is easily producible.

For example, in the printer according to the one aspect, the one of the first protrusion and the second protrusion may include a surface brought into contact with the other of the first protrusion and the second protrusion when the rotating body rotates in the first direction. In this case, the surface may be configured at right angles relative to a surface from which the one of the first protrusion and the second protrusion protrudes.

According to this aspect, the first protrusion or the second protrusion easily comes into a hole, and rapidly returns to the position outside the hole.

For example, in the printer according to the one aspect of various preferred embodiments of the present invention, the one of the first protrusion and the second protrusion may be supported by an elastic member provided in a hole recessed in a surface from which the one of the first protrusion and the second protrusion protrudes.

According to this aspect, the first protrusion or the second protrusion easily comes into the hole, and rapidly returns to the position outside the hole by elastic force.

For example, in the printer according to the one aspect of various preferred embodiments of the present invention, the rotating body may be connected with a driven pulley that holds a belt provided to reciprocate the carriage.

According to this aspect, the driving force of the motor generated to drive the carriage is transmitted to the rotating body via the driven pulley, a timing belt, and a driving pulley to rotate the rotating body. In this case, the necessity of providing a dedicated motor to rotate the fan is eliminated. Accordingly, a reduction of the number of components of the printer, and therefore a reduction of the size of the printer are achieved. Moreover, the fan is fixed to the driven pulley to which the motor that reciprocates the carriage of the printer is not connected, so that a free space within the printer is effectively used. Accordingly, space saving and size reduction of the printer are achieved.

For example, the printer according to the one aspect of various preferred embodiments of the present invention may include a temperature detector that detects a temperature within the printer. In this case, a driving force may be transmitted from the driven pulley to the rotating body when the temperature detected by the temperature detector is equal to or higher than a predetermined temperature.

According to this aspect, the fan is rotated only when the temperature within the printer is higher than the predetermined temperature. Accordingly, air heated by heat generated from the printer is dischargeable to the outside of the housing with higher efficiency of rotation of the fan.

For example, the printer according to the one aspect of various preferred embodiments of the present invention may include a clutch that includes a first gear connected with the driven pulley; and a driver that drives the clutch. In this case, the clutch may include a second gear connected with the rotating body, and be brought into engagement with the first gear by the driver.

According to this aspect, the clutch provided for transmission of rotation of the motor to the cooling assembly allows rotation of the fan only when the temperature within the printer is higher than the predetermined temperature. Accordingly, air heated by heat generated from the printer is dischargeable to the outside of the housing with higher efficiency of rotation of the fan.

Printers according to various preferred embodiments of the present invention are capable of preventing heating and causing damage to components of the printer while achieving size reduction of the printer.

The above and other elements, features, steps, characteristics and advantages of the present invention will become more apparent from the following detailed description of the preferred embodiments with reference to the attached drawings.

### BRIEF DESCRIPTION OF THE DRAWINGS

FIG. 1 is a perspective view illustrating an external appearance of a printer according to a first preferred embodiment of the present invention.

FIG. 2A is a perspective view illustrating a portion of an internal structure of the printer according to the first preferred embodiment of the present invention.

FIG. 2B is a front view illustrating a portion of the internal structure of the printer according to the first preferred embodiment of the present invention.

FIG. 3 is a schematic configuration diagram of a cooling assembly of the printer according to the first preferred embodiment of the present invention.

FIG. 4A is a plan view illustrating operation of a fan of the printer according to the first preferred embodiment of the present invention.

FIG. 4B is a plan view illustrating the operation of the fan of the printer according to the first preferred embodiment of the present invention.

FIG. 5 illustrates an example of operation of the printer according to the first preferred embodiment of the present invention.

FIG. 6 is a schematic configuration diagram of a cooling assembly of a printer according to a second preferred embodiment of the present invention.

FIG. 7A is a plan view illustrating operation of a fan of the printer according to the second preferred embodiment of the present invention.

FIG. 7B is a plan view illustrating the operation of the fan of the printer according to the second preferred embodiment of the present invention.

FIG. 8A is a schematic configuration diagram of a cooling assembly of a printer according to a third preferred embodiment of the present invention.

FIG. 8B is a schematic configuration diagram of the operation of the cooling assembly of the printer according to the third preferred embodiment of the present invention.

FIG. 9A is a pan view illustrating operation of a fan of a printer according to a fourth preferred embodiment of the present invention.

FIG. 9B is a plan view illustrating the operation of the fan of the printer according to the fourth preferred embodiment of the present invention.

### DETAILED DESCRIPTION OF THE PREFERRED EMBODIMENTS

Preferred embodiments according to the present invention are hereinafter described in detail with reference to the drawings. Each of the preferred embodiments detailed herein is a preferred specific but non-limiting example of the present invention. Numerical values, shapes, materials, constituent elements, positions of the constituent elements, connection manners and others described in the following preferred embodiments are presented only by way of example, and not intended to limit the scope of the present invention. The scope of the present invention is only defined by the appended claims. Accordingly, constituent elements contained in the constituent elements described in the following preferred embodiments but not included in the independent claims are regarded as elements not essential to the present invention but constituting more preferable aspects or embodiments.

### First Preferred Embodiment

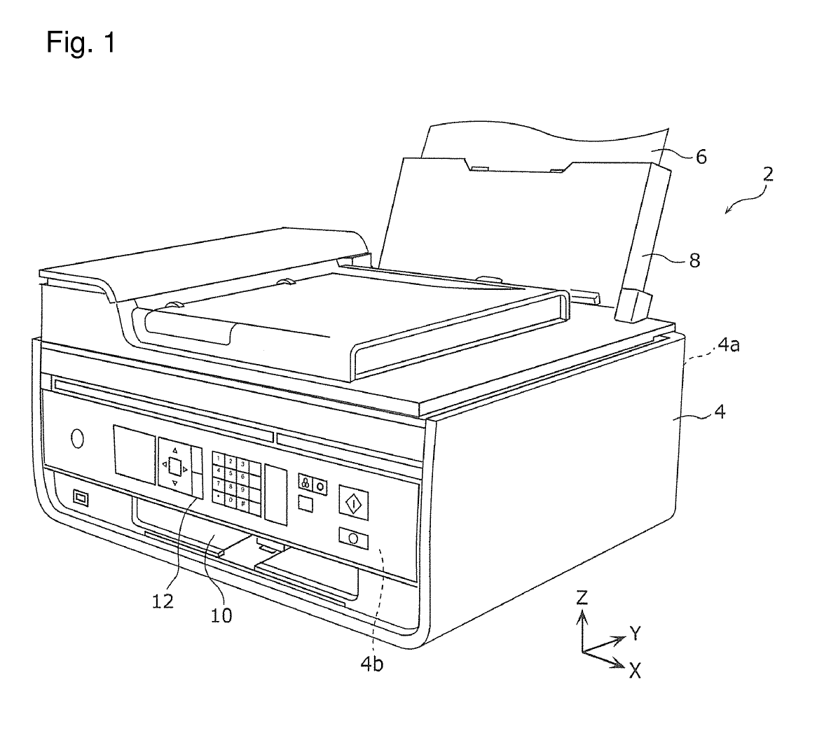

An external structure of a printer 2 according to a first preferred embodiment of the present invention is hereinafter described with reference to FIG. 1. FIG. 1 is a perspective view illustrating an external appearance of the printer 2 according to the first preferred embodiment.

As illustrated in FIG. 1, the printer 2 includes a housing 4. A feed tray 8 is provided on a rear panel 4a of the housing 4. A recording medium 6 before printing is set on the feed tray 8. The recording medium 6 may be plain paper or photographic paper, for example. A discharge tray 10 is provided on a front panel 4b of the housing 4. The recording medium 6 after printing is discharged through the discharge tray 10. An operation panel 12 is further provided on the front panel 4b of the housing 4. The operation panel 12 is operated when various types of operation are performed.

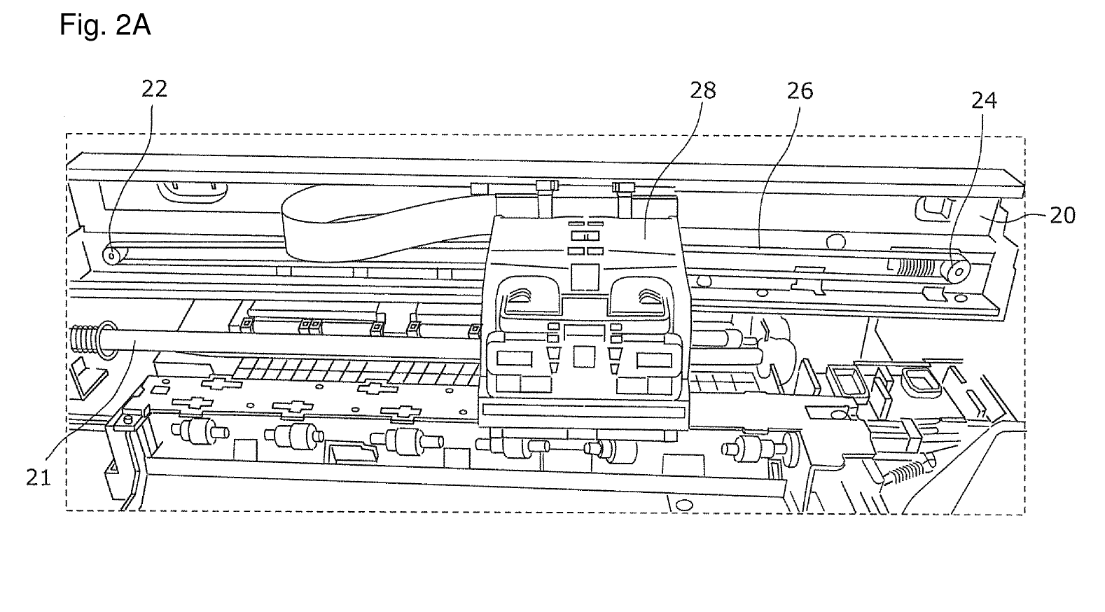

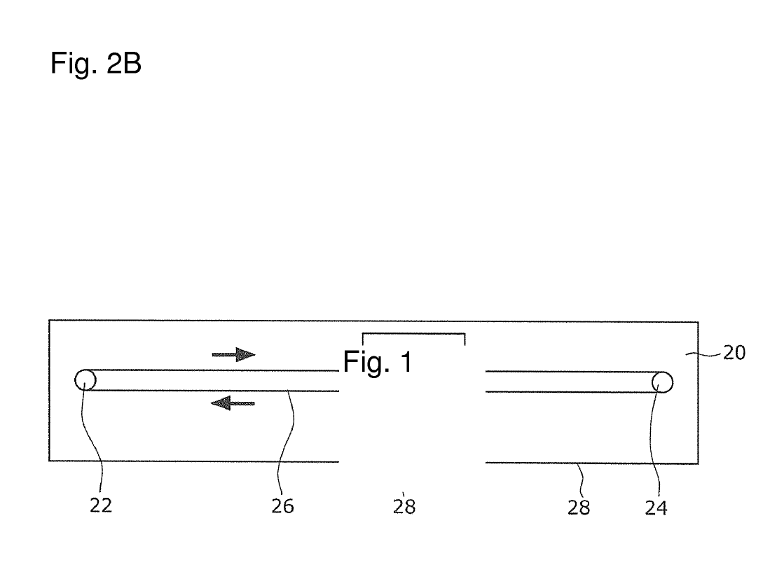

An internal structure of the printer 2 is hereinafter described with reference to FIGS. 2A and 2B. FIG. 2A is a perspective view illustrating the internal structure of the printer 2 according to the first preferred embodiment. FIG. 2B is a front view illustrating a portion of the internal structure of the printer 2 according to the first preferred embodiment.

As illustrated in FIG. 2A, a frame 20 is provided inside the housing 4 of the printer 2. The frame 20 is supported on a bottom of the housing 4, and extends in an X axis direction from one side of the housing 4 toward the other side of the housing 4. There are provided on the frame 20 a driving pulley 22, a driven pulley 24, a timing belt 26 wound around the driving pulley 22 and the driven pulley 24 and extended between the driving pulley 22 and the driven pulley 24, and a carriage 28 configured to linearly reciprocate in accordance with movement of the timing belt 26.

A pair of side frames are connected with both ends of the frame 20 such that one and the other side frames connect with one and the other ends of the frame 20, respectively. Accordingly, the pair of side frames are disposed to face each other. A top frame is connected with an upper end of the frame 20 so as to extend between respective upper ends of the pair of side frames.

A guide shaft 21 extends between the pair of side frames. The guide shaft 21 extends in a direction crossing a conveyance direction of the recording medium 6 at right angles or substantially at right angles (i.e., the guide shaft 21 extends in the X axis direction in FIG. 1). The carriage 28 is movably supported on the guide shaft 21.

A plurality of replaceable print heads (not shown) preferably are mounted on the carriage 28. Each of the plurality of print heads is filled with ink in a corresponding color of black, cyan, magenta, and yellow, for example. Each of the plurality of print heads is mounted on the carriage 28 in such a position that nozzles of the recording head face the recording medium 6.

In printing an image on the recording medium 6, the carriage 28 linearly reciprocates along the guide shaft 21 by a function of a driving mechanism (described later). The recording medium 6 is conveyed in a direction indicated by an arrow in FIG. 2B by a function of a conveying mechanism (not shown) provided within the housing 4. In this condition, ink is ejected from the nozzles of the print heads toward the recording medium 6 to print an image on the recording medium 6.

The driving mechanism to drive the carriage 28 noted above is hereinafter described with reference to FIG. 2B.

A motor (constituting a driving source) is connected with the driving pulley 22. The motor preferably is a servomotor to drive the carriage 28. In FIG. 2B, the motor is positioned on a surface of the frame 20 on the side opposite to the side where the driving pulley 22 is disposed. The motor is supported on the frame 20.

The driving pulley 22 is fixed to an end of an output shaft of the motor. The driving pulley 22 rotates in accordance with rotation of the output shaft of the motor as one piece body of the driving pulley 22 and the output shaft. The motor is rotatable in both a forward direction and a backward direction.

The driven pulley 24 is rotatably supported on the frame 20.

The timing belt 26 preferably is an endless toothed belt, for example, and rotatably wound around the driving pulley 22 and the driven pulley 24. The timing belt 26 converts rotary movement of the motor into reciprocating movement of the carriage 28. The timing belt 26 rotates in linkage with the rotation of the driving pulley 22.

The driving pulley 22 and the driven pulley 24 correspond to a driving pulley and a driven pulley according to a preferred embodiment of the present invention, respectively.

A portion of the timing belt 26 is pressed downward by a shaft (not shown) of an actuator. This press makes mutual connection between the carriage 28 and the timing belt 26. In this state, the motor connected with the driving pulley 22 rotates alternately in the forward direction and the backward direction to allow the carriage 28 to reciprocate along the guide shaft 21 with a pull of the timing belt 26.

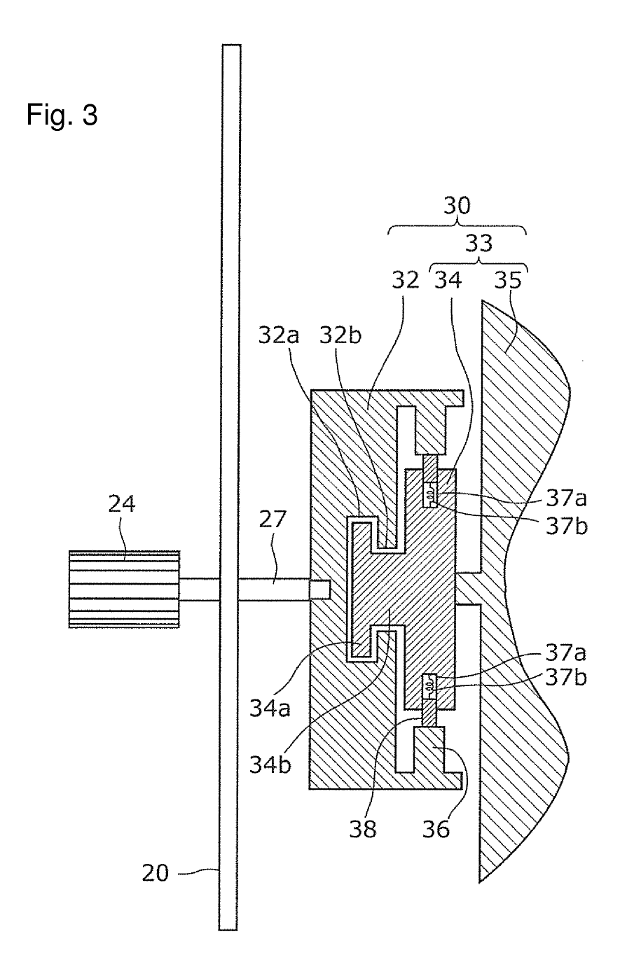

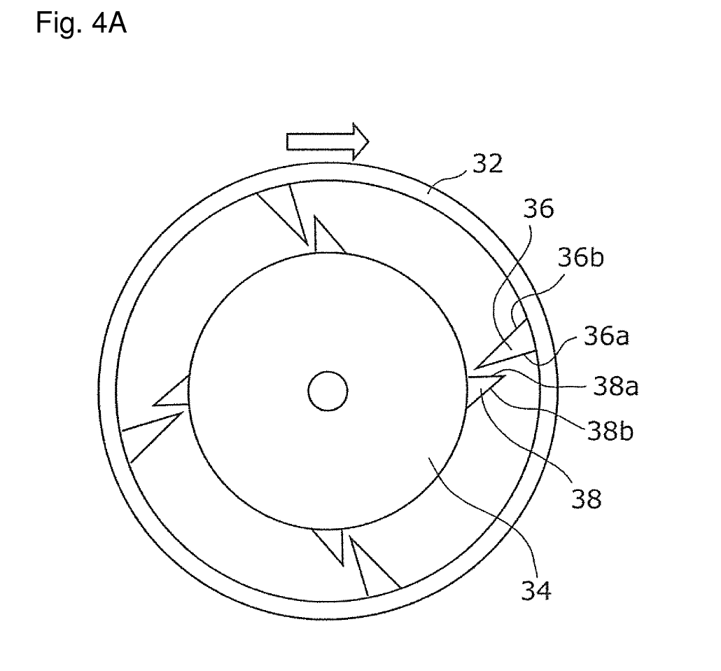

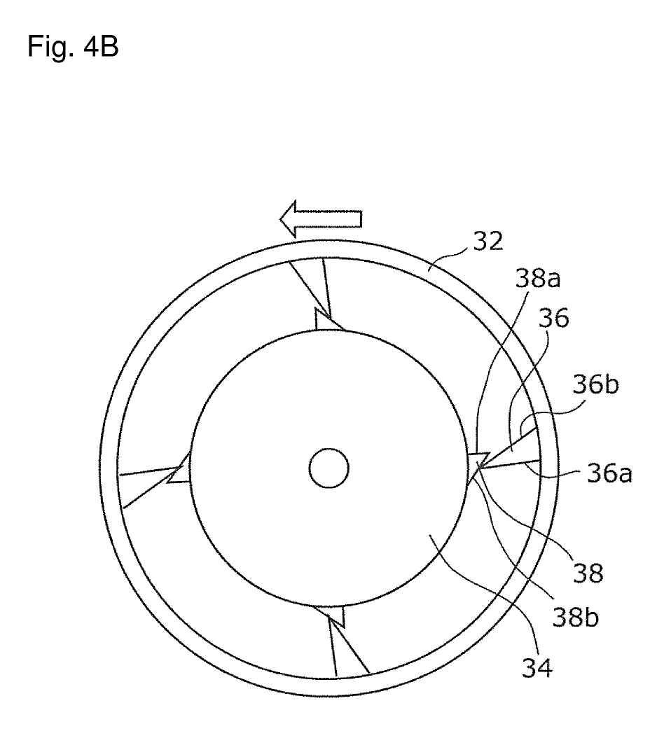

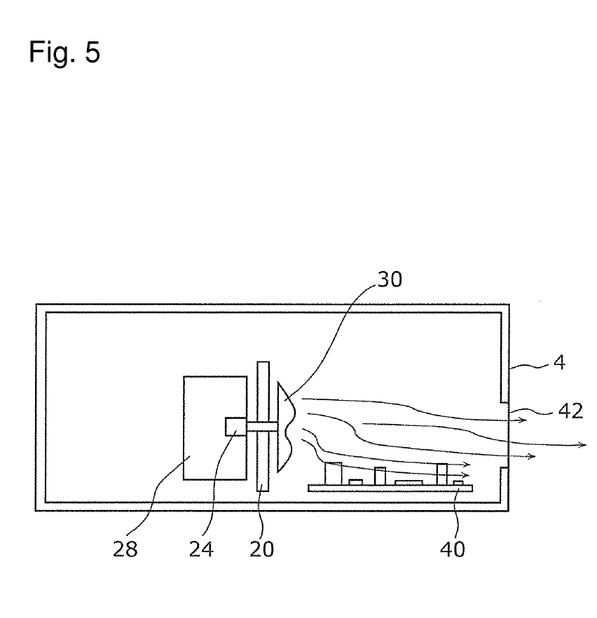

A cooling mechanism corresponding to a distinctive feature of the printer 2 according to this preferred embodiment is hereinafter described with reference to FIGS. 3 through 5. FIG. 3 is a view schematically illustrating a cooling assembly of the printer 2 according to the first preferred embodiment. FIG. 4A is a plan view illustrating operation of a fan of the printer 2 according to the first preferred embodiment. FIG. 4B is a plan view illustrating the operation of the fan of the printer 2 according to the first preferred embodiment. FIG. 5 is a view illustrating an example of operation of the printer 2 according to the first preferred embodiment.

As illustrated in FIG. 3, the printer 2 according to the first preferred embodiment includes a cooling assembly 30 which discharges heat generated inside the housing 4 to the outside of the housing 4. The heat inside the housing 4 is chiefly generated from electric circuits provided on a printed circuit board.

The cooling assembly 30 includes a rotating body 32 and a fan 33. The rotating body 32 of the cooling assembly 30 is connected with the driven pulley 24 via a shaft 27.

The rotating body 32 is rotated by a driving force of the motor generated to drive the carriage 28. The rotating body 32 preferably has a hollow cylindrical shape, more specifically, a shape constituted by a cylindrical side wall, and a circular bottom wall defining a bottom of the cylindrical rotating body. The rotating body 32 surrounds the circumference of a base 34 of the fan 33 (described later). As illustrated in FIG. 3, a support hole is provided in the bottom wall inside the cylindrical shape in the vicinity of the center of the bottom, as a hole in which the base 34 is supported. The support hole includes a cylindrical opening 32a and a cylindrical inner void 32b. The diameter of the opening 32a is larger than the diameter of the inner void 32b. The rotating body 32 rotates in a first direction (the direction of the arrow in FIG. 4A) when the motor rotates in the forward direction. On the other hand, the rotating body 32 rotates in a second direction (the direction of the arrow in FIG. 4B) opposite to the first direction when the motor rotates in the backward direction.

The fan 33 includes the base 34 and a blade assembly 35. The base 34 rotates together with the blade assembly 35. As will be detailed later, the fan 33 rotates in the first direction by contact between claws 36 corresponding to a portion of the rotating body 32 and claws 38 corresponding to a portion of the fan 33 at the time of rotation of the rotating body 32 in the first direction.

The base 34 is disk-shaped or substantially disk-shaped. The blade assembly 35 is fixed to one surface of the disk shape of the base 34. The base 34 includes a support portion supported in the support hole of the rotating body 32. The support portion is provided on the surface of the base 34 on the side opposite to the surface to which the blade assembly 35 is fixed. The support portion includes a first support portion 34a and a second support portion 34b rotatably supported in a state of engagement between the first support portion 34a and the opening 32a of the rotating body 32 and between the second support portion 34b and the inner void 32b of the rotating body 32.

The blade assembly 35 includes a plurality of blades disposed at equal or substantially equal angles and integrally formed into a one-piece body. The angles of the plurality of blades with respect to the disk-shaped surface of the base 34 are adjusted such that airflow is moved from the fan 33 toward the front of the fan 33 at the time of rotation of the fan 33 in the first direction.

As illustrated in FIGS. 3, 4A and 4B, the rotating body 32 and the fan 33 include the claws 36 and the claws 38, respectively. The claws 36 and the claws 38 have the following configuration to allow engagement with each other at the time of rotation of the rotating body 32 in the first direction.

The rotating body 32 includes the claws 36 each of which has a triangular or substantially triangular prism shape protruding from the inner circumferential side of the side wall of the cylindrical shape. As illustrated in FIG. 4A, a surface constituting a side of a triangle of each of the claws 36 is fixed to the inner circumference of the rotating body 32 as viewed in an axial direction of the rotation of the rotating body 32. A surface 36a constituting another side of the triangle of each of the claws 36 is arranged at right angles relative to the inner circumferential surface of the rotating body 32. A surface 36b constituting the remaining side of the triangle is inclined relative to the inner circumferential surface of the rotating body 32 from which the claw 36 protrudes. The inclination of the surface 36b is determined in such a direction not interrupting actions of the claws 38. The right angles in this context are not limited to precise angles constituted by right angles (90°), but include angles constituted by substantially right angles. The surface 36a and the surface 36b correspond to a second surface and a first surface, respectively.

The fan 33 includes the claws 38 each of which has a triangular or substantially triangular prism shape and located on the outer circumference of the side wall of the base 34. FIGS. 4A and 4B do not show the blade assembly 35. As illustrated in FIG. 4A, each of the claws 38 is supported by an elastic member 37b disposed within a hole 37a recessed in the surface from which the claw 38 protrudes (i.e., circumferential surface of the base 34) when the base 34 of the fan 33 is viewed in the axial direction of the rotation. Accordingly, as will be detailed later, a surface of each of the claws 38 constituting a side of a triangle is supported by the elastic member 37b disposed within the hole 37a provided in the side wall of the base 34. A surface 38a constituting another side of the triangle of each of the claws 38 is arranged at right angles with respect to the outer circumferential surface of the base 34. A surface 38b constituting the remaining side of the triangle is inclined relative to the outer circumferential surface of the base 34 from which the claw 38 protrudes. The inclination of the surface 38b is determined in such a direction not interrupting actions of the claws 36. The right angles in this context are not limited to precise angles constituted by right angles (90°), but include angles constituted by substantially right angles. The surface 38a and the surface 38b correspond to the second surface and the first surface, respectively.

According to this configuration, the claws 38 gradually come into the corresponding holes 37a located in the side wall of the base 34 when receiving a pressing force from the outside, and protrude from the holes 37a of the base 34 when not receiving the pressing force.

The elastic member 37b noted above preferably is constituted by a spring mechanism, for example. However, the elastic member 37b supporting the claw 38 is not limited to the spring mechanism, but maybe arbitrary types of components having elasticity.

As illustrated in FIGS. 4A and 4B, the claws 36 and the claws 38 are arranged such that the surfaces 36a of the claws 36 face the surfaces 38a of the claws 38, and that the surfaces 36b of the claws 36 face the surfaces 38b of the claws 38. This configuration allows engagement between the claws 38 and the claws 36 when the rotating body 32 rotates in the first direction, as will be described later. When the rotating body 32 rotates in the second direction opposite to the first direction, the claws 38 receive a pressing force from the claws 36 and gradually come into the holes 37a of the base 34 of the fan 33 in such a manner as to escape from the claws 36 without engagement with the claws 36.

The claws 36 and the claws 38 according to this preferred embodiment correspond to a first protrusion and a second protrusion, respectively.

Cooling operations performed by the cooling mechanism having the foregoing structure to cool the printed circuit board is hereinafter described with reference to FIGS. 4A, 4B and 5. FIG. 5 is a view illustrating an example of operation of the printer 2 according to the first preferred embodiment.

In response to a start of printing in a standby state of the carriage 28 at a home position in the printer 2, the carriage 28 starts reciprocation along the guide shaft 21 in accordance with alternate rotation of the motor in the forward direction and the backward direction. Along with reciprocation of the carriage 28, the recording medium 6 set on the feed tray 8 is conveyed toward the discharge tray 10. During conveyance of the recording medium 6 in this condition, ink is ejected from the nozzles of the print heads held by the carriage 28 toward the recording medium 6 to print an image on the recording medium 6.

Details of the reciprocation of the carriage 28 are hereinafter described.

The driving pulley 22 connected with the motor rotates alternately in the first direction and the second direction in accordance with rotation of the motor. In this case, the timing belt 26 wound around the driving pulley 22 also shifts alternately in the first direction and the second direction in accordance with rotation of the driving pulley 22. In this condition, the driven pulley 24 around which the timing belt 26 is wound further rotates alternately in the first direction and the second direction in accordance with the shift of the timing belt 26. As a result, the carriage 28 around which the timing belt 26 is wound initiates reciprocation along the guide shaft 21.

At this time, the rotating body 32 connected with the driven pulley 24 rotates alternately in the first direction and the second direction in the cooling assembly 30 in accordance with rotation of the driven pulley 24. Accordingly, the fan 33 supported by the rotating body 32 moves in the following manner.

When the rotating body 32 rotates in the first direction as illustrated in FIG. 4A, the surfaces 36a of the claws 36 provided on the rotating body 32 engage with the surfaces 38a of the claws 38 provided on the base 34 of the fan 33. In this case, the claws 38 receive a pressing force in the first direction from the claws 36. As a result, the fan 33 rotates in the first direction such that airflow is moved from the fan 33 toward the front of the fan 33.

When the rotating body 32 subsequently rotates in the second direction as illustrated in FIG. 4B, the surfaces 36b of the claws 36 provided on the rotating body 32 contact the surfaces 38b , of the claws 38 provided on the base 34 of the fan 33. The surfaces 38b of the claws 38 are inclined so as not to interrupt rotating actions of the claws 36 in the second direction. As a result, the surfaces 38b receive a pressing force from the claws 36, and gradually come into the corresponding holes 37a of the base 34 in accordance with the strength of the pressing force. After the claws 36 pass through the tops of the claws 38, the claws 38 again protrude from the corresponding holes 37a of the base 34 by the elastic force of the elastic members 37b with the release of the pressing force from the claws 36. Accordingly, the fan 33 continues rotation in the first direction without rotation in the second direction.

Thereafter, with rotation of the rotating body 32 again in the first direction, the surfaces 36a of the claws 36 provided on the rotating body 32 engage with the surfaces 38a of the claws 38 disposed on the base 34 of the fan 33 as discussed above. As a result, the claws 38 receive a pressing force in the first direction from the claws 36, in which condition the fan 33 rotates in the first direction.

These actions allow rotation of the fan 33 only in the first direction even in the condition of rotation of the rotating body 32 in either the first direction or the second direction. Accordingly, airflow is moved from the fan 33 toward the front of the fan 33.

During rotation of the rotating body 32 in the second direction, the fan 33 rotates at a slower speed than the rotation speed of the fan 33 during rotation of the rotating body 32 in the first direction in some cases due to generation of friction force between the claws 38 and the claws 36, for example. Even in this case, the fan 33 does not rotate in the second direction, wherefore the push of airflow is maintained from the fan 33 toward the front of the fan 33.

When the rotating body 32 stops after rotation in the first direction, the fan 33 continues rotation in the first direction by inertia force without engagement between the claws 36 and the claws 38, in a manner similar to the rotation of the fan 33 during the rotation of the rotating body 32 in the second direction.

As illustrated in FIG. 5, the housing 4 includes a discharge port 42 through which air is discharged to the outside of the housing 4. The air heated by heat generated from the printed circuit board is discharged from the discharge port 42 provided in the housing 4 of the printer 2 to the outside of the housing 4 in accordance with the airflow that flows from the fan 33 toward the front of the fan 33. A mesh-type cover member may be attached to the discharge port 42, for example, to prevent entrance of foreign bodies into the housing 4.

As described above, airflow is moved from the fan 33 toward the front of the fan 33 in accordance with rotation of the motor in either the first direction or the second direction for reciprocating the carriage 28. The airflow thus produced discharges air heated by heat generated in the housing 4 toward the outside of the housing 4. Accordingly, thermal damage to components is prevented.

As described above, airflow is moved from the fan 33 toward the front of the fan 33 in accordance with rotation of the motor in either the first direction or the second direction for reciprocating the carriage 28. The airflow thus produced discharges air heated by heat generated in the housing 4 toward the outside of the housing 4. Accordingly, thermal damage to components is prevented.

Moreover, the fan 33 is fixed to the driven pulley 24 to which the motor is not connected, so that the space within the printer 2 is able to be effectively used. Accordingly, space saving and size reduction of the printer 2 are achieved.

Furthermore, the driving force of the motor generated to drive the carriage 28 is transmitted to the cooling assembly 30 via the driven pulley 24, the timing belt 26, and the driving pulley 22 to rotate the cooling assembly 30. In this case, the necessity of providing a dedicated motor to rotate the fan is eliminated. Accordingly, reduction of the number of parts of the printer 2, and therefore reduction of the size of the printer 2 are achieved.

### Second Preferred Embodiment

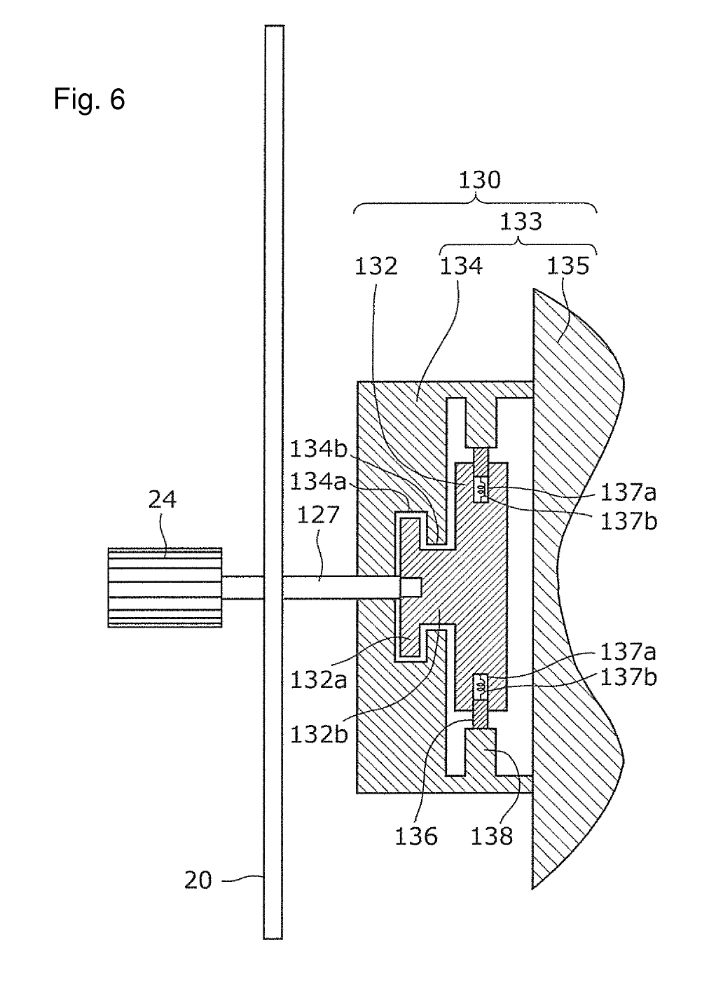

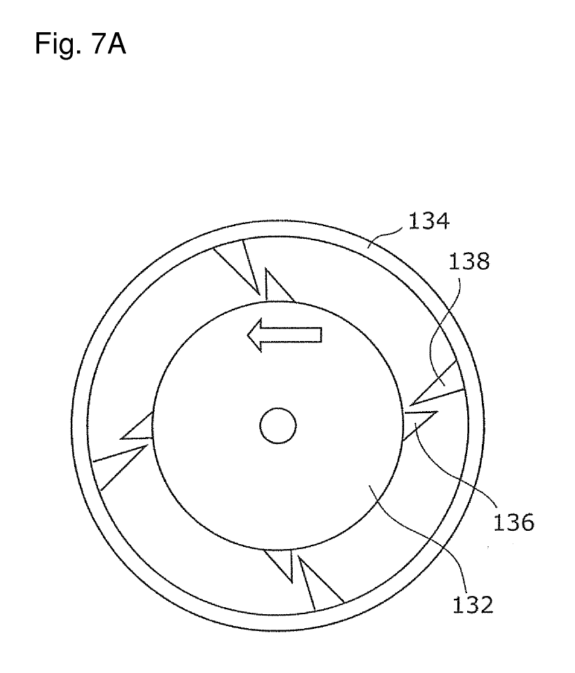

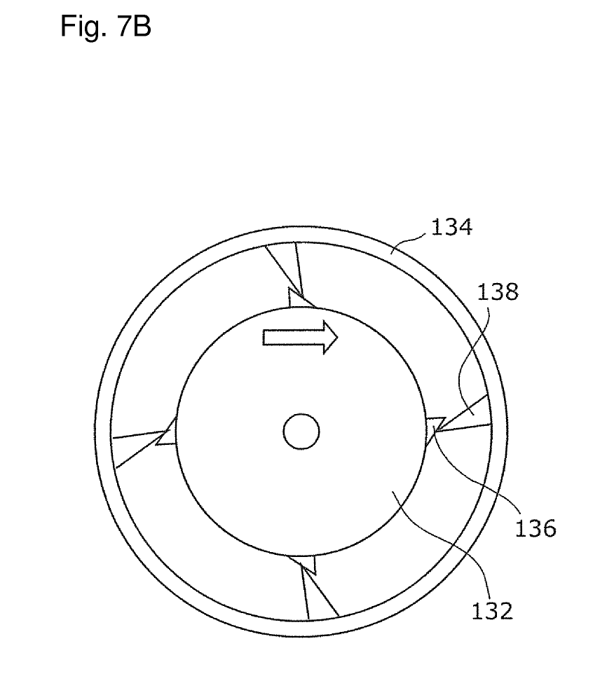

A configuration of a printer according to a second preferred embodiment of the present invention is hereinafter described with reference to FIGS. 6, 7A and 7B. FIG. 6 is a schematic configuration diagram of a cooling assembly of the printer according to the second preferred embodiment. FIGS. 7A and 7B are plan views illustrating operation of a fan of the printer according to the second preferred embodiment. In the respective preferred embodiments described hereinafter, constituent elements similar to the corresponding constituent elements described in the foregoing first preferred embodiment have been given similar reference numbers, and the same explanation is not repeated.

The printer according to this preferred embodiment is different from the printer according to the first preferred embodiment in that a fan 133 is disposed outside a rotating body 132.

As illustrated in FIG. 6, a cooling assembly 130 of the printer 2 in the present preferred embodiment is connected with the driven pulley 24 via a shaft 127. The cooling assembly 130 includes the rotating body 132 and the fan 133.

The fan 133 includes a base 134 and a blade assembly 135. The base 134 has a hollow cylindrical shape, more specifically, a shape constituted by a cylindrical side wall, and a circular bottom wall defining a bottom of the cylindrical rotating body. The base 134 surrounds the circumference of the rotating body 132 (described later). The blade assembly 135 is fixed to the peripheral edge of the side wall of the cylindrical shape.

The blade assembly 135 includes a plurality of blades disposed at equal or substantially equal angles and integrally formed into a one-piece body. The angles of the plurality of blades with respect to a disk-shaped surface of the rotating body 132 are adjusted such that airflow is moved from the fan 133 toward the front of the fan 133 at the time of rotation of the fan 133 in the first direction.

The circular bottom wall includes a support hole in which the rotating body 132 is supported. The support hole includes a cylindrical opening 134a and a cylindrical inner void 134b. The diameter of the opening 134a is larger than the diameter of the inner void 134b.

The rotating body 132 is rotated by the driving force of the motor to drive the carriage 28.

The blade assembly 135 is disk-shaped or substantially disk-shaped. A support portion is provided on a surface of the blade assembly 135 on the side opposite to the side where the blade assembly 135 is disposed. The support portion is supported in the support hole of the base 134. The support portion includes a third support portion 132a and a fourth support portion 132b rotatably supported in a state of engagement between the third support portion 132a and the opening 134a of the base 134 and between the fourth support portion 132b and the inner void 134b of the base 134.

The rotating body 132 is connected with the driven pulley 24 via a shaft 127. The rotating body 132 rotates in the first direction (direction of arrow in FIG. 4A) when the motor rotates in the forward direction. On the other hand, the rotating body 132 rotates in the second direction (direction of arrow in FIG. 4B) opposite to the first direction when the motor rotates in the backward direction.

As illustrated in FIGS. 6, 7A and 7B, the rotating body 132 and the fan 133 include claws 136 and claws 138, respectively. The claws 136 and the claws 138 are similar to the claws 36 and the claws 38 discussed in the first preferred embodiment, respectively, such that detailed explanation of the claws 136 and the claws 138 is not presented herein. FIGS. 7A and 7B do not show the blade assembly 135.

Each of the claws 136 is supported by an elastic member 137b disposed within a hole 137a located in the side wall of the rotating body 132. When receiving pressing force from the outside, the claws 136 gradually come into the corresponding holes 137a located in the outer circumference of the rotating body 132 in accordance with the strength of the pressing force. When the pressing force is released, the claws 136 protrude from the corresponding holes 137a of the rotating body 132.

According to this preferred embodiment, the claws 136 and the claws 138 correspond to the first protrusion and the second protrusion according to a preferred embodiment of the present invention.

This configuration allows rotation of the fan 133 only in the first direction in accordance with rotation of the rotating body 132 in either the first direction or the second direction, and pushes airflow from the fan 133 toward the front of the fan 133. The airflow thus produced discharges air heated by heat generated in the housing 4 toward the outside of the housing 4. Accordingly, thermal damage to components is prevented.

### Third Preferred Embodiment

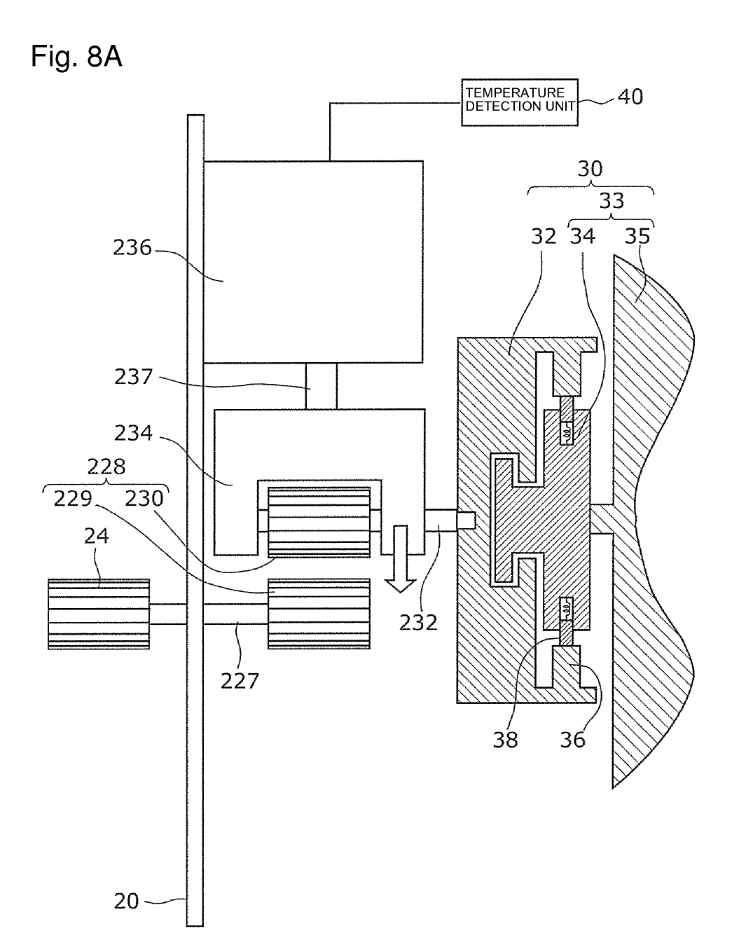

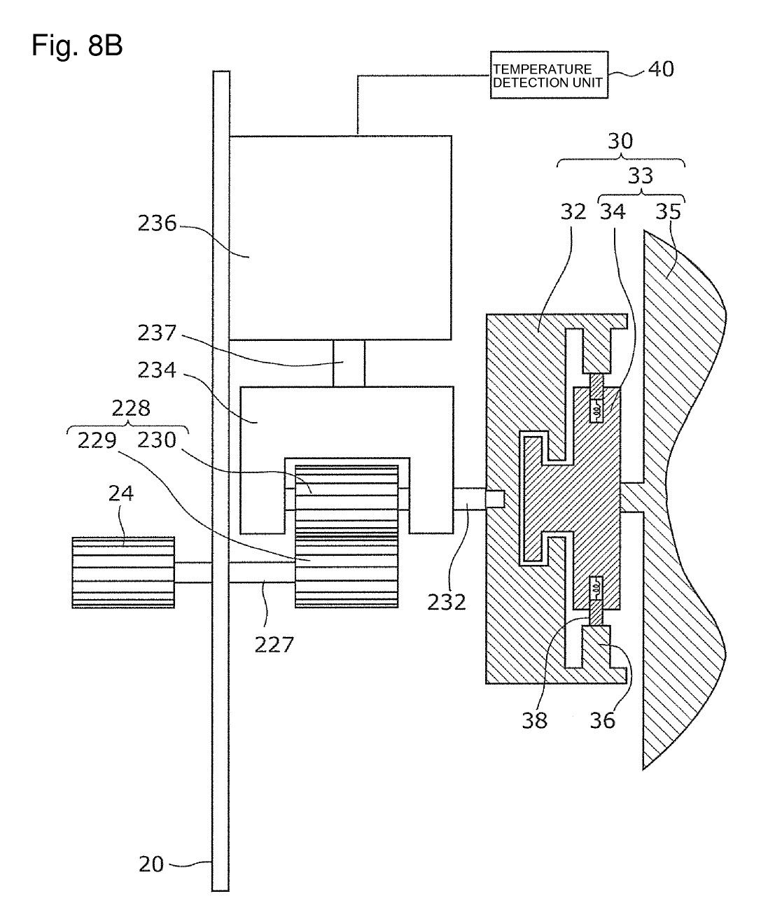

A configuration of a printer according to a third preferred embodiment of the present invention is hereinafter described with reference to FIGS. 8A and 8B. FIG. 8A is a schematic configuration diagram of a cooling assembly of the printer according to the third preferred embodiment. FIG. 8B is a schematic configuration diagram of the operation of the cooling assembly of the printer according to the third preferred embodiment.

The printer according to this preferred embodiment is different from the printer according to the first preferred embodiment in that the driving force of the motor is transmitted to the fan when a temperature detected by a temperature detector becomes a predetermined temperature or higher, and is not transmitted to the fan when the temperature detected by the temperature detector is lower than the predetermined temperature.

As illustrated in FIGS. 8A and 8B, a clutch 228 is provided between the driven pulley 24 and the cooling assembly 30 in the printer 2 according to this preferred embodiment. The clutch 228 is equipped with a driver 236 to drive the clutch 228.

The clutch 228 includes a gear 229 and a gear 230. The gear 229 is fixed to a shaft 227. In other words, the gear 229 is fixed to the driven pulley 24. The gear 230 is so disposed as to face the gear 229. The gear 230 is fixed to a shaft 232. The shaft 232 is rotatably supported by a bearing 234. A shaft 237 is fixed to the bearing 234. The shaft 237 is movably supported on the driver 236. The gear 229 and the gear 230 correspond to a first gear and a second gear, respectively.

The driver 236 preferably is an electromagnetic solenoid, for example. The shaft 237 moves in an up-down direction in FIG. 8A (i.e., Z-axis direction of printer 2) relatively to the driver 236 in accordance with driving of the driver 236. Accordingly, the bearing 234 and the gear 230 supported on the bearing 234 move in the up-down direction. In accordance with movement of the bearing 234 and the gear 230, the gear 230 switches between a state of engagement with the gear 229 and a state of disengagement from the gear 229.

In the state of engagement between the gear 230 and the gear 229, rotation of the driven pulley 24 is transmitted via the shaft 227, the gears 229 and 230, and the shaft 232 to the cooling assembly 30. In this case, the cooling assembly 30 operates in a manner similar to the operation of the cooling assembly 30 discussed in the first preferred embodiment. As a result, airflow is moved from the fan 33 toward the front of the fan 33.

The printer 2 according to this preferred embodiment includes a temperature detector 40 provided inside the printer 2. The temperature detector 40 is disposed on the printed circuit board.

When the temperature detected by the temperature detector 40 is lower than a predetermined temperature (such as about 40° C., for example), the driver 236 moves the shaft 237 upward to disengage the gear 230 from the gear 229. When the gear 230 is disengaged from the gear 229, the driver 236 stops operation and maintains the state of disengagement between the gear 230 and the gear 229. In this case, the rotation of the driven pulley 24 is not transmitted to the cooling assembly 30, such that the fan 33 does not rotate.

When the temperature detected by the temperature detector 40 is the predetermined temperature or higher, the driver 236 shifts the shaft 237 downward. In this case, the gear 230 engages with the gear 229, such that the rotation of the driven pulley 24 is transmitted to the cooling assembly 30. As a result, the fan 33 starts rotation, in which condition air heated by heat generated from the printer is discharged to the outside of the housing 4.

The method to block transmission of rotation of the driven pulley 24 to the cooling assembly 30 in the printer 2 is not limited to the method using the operation of the driver 236 and the clutch 228, but may be a method using another configuration not including the driver 236 and the clutch 228. For example, a retractable shaft may be used for connection between the driven pulley 24 and the cooling assembly 30. In this case, the retractable shaft is retracted from the driven pulley 24 when the temperature detected by the temperature detector 40 is lower than the predetermined temperature. This retraction of the retractable shaft is able to directly disconnect the driven pulley 24 from the cooling assembly 30.

According to the printer 2 in this preferred embodiment, the fan 33 is able to rotate only when the temperature within the printer exceeds the predetermined temperature. Accordingly, air heated by heat generated from the printer 2 is dischargeable to the outside of the housing 4 with higher efficiency of operation of the fan 33.

### Fourth Preferred Embodiment

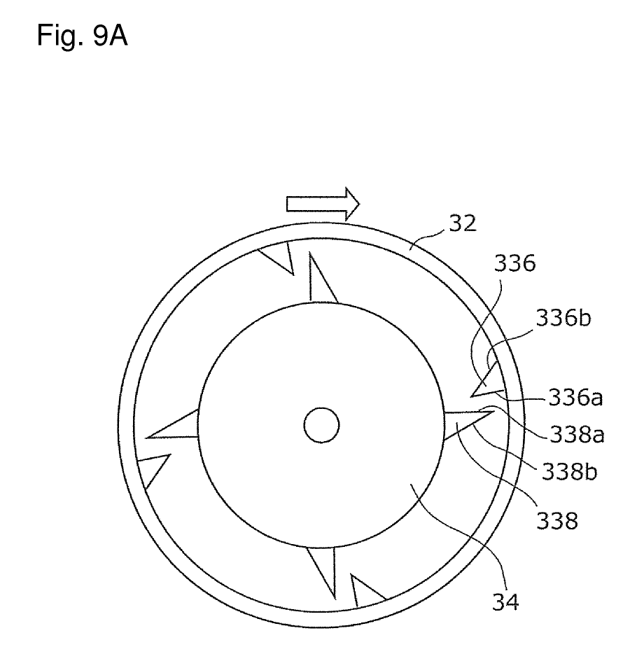

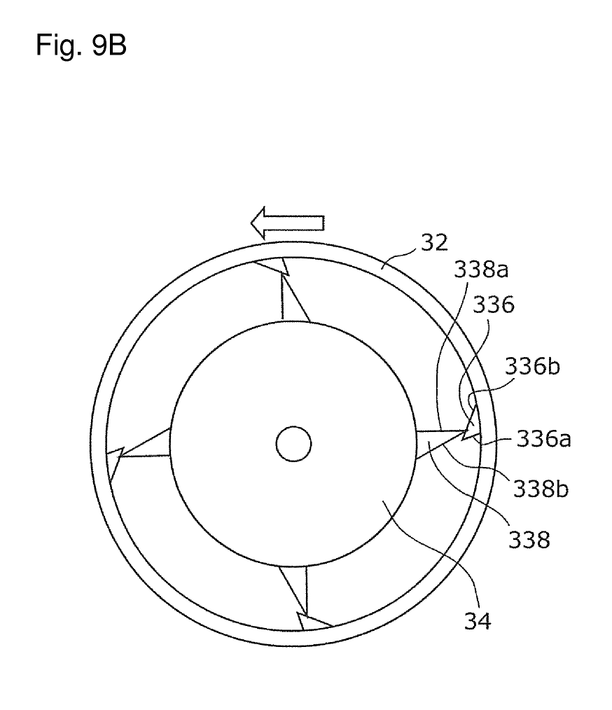

A configuration of a printer according to a fourth preferred embodiment of the present invention is hereinafter described with reference to FIGS. 9A and 9B. FIG. 9A is a plan view illustrating operation of a fan included in the printer according to the fourth preferred embodiment. FIG. 9B is a plan view illustrating the operation of the fan included in the printer according to the fourth preferred embodiment.

The printer according to this preferred embodiment is different from the printer according to the first preferred embodiment in that claws provided on the rotating body escape from claws provided on the fan when the rotating body rotates in the second direction.

As illustrated in FIGS. 9A and 9B, the rotating body 32 includes claws 336 each of which has a triangular or substantially triangular prism shape and protrudes from the inner circumferential side of the side wall of the cylindrical shape. The fan 33 includes the claws 338 each of which has a triangular or substantially triangular prism shape and is located on the outer circumference of the side wall of the base 34. FIGS. 9A and 9B do not show the blade assembly.

As illustrated in FIG. 9A, a side constituting a triangle of each of the claws 336 is supported by an elastic member (not shown) disposed within a hole (not shown) located in the side wall of the rotating body 32 as viewed in the axial direction of the rotation of the rotating body 32. A surface 336a constituting another side of the triangle of each of the claws 336 is arranged at right angles relative to the inner circumferential surface of the rotating body 32. A surface 336b constituting the remaining side of the triangle is inclined relative to the inner circumferential surface of the rotating body 32 so as not to interrupt actions of the claws 338. This configuration allows the claws 336 to gradually come into the corresponding holes located in the side wall of the rotating body 32 when receiving a pressing force from the outside, and protrude from the corresponding holes when not receiving the pressing force.

As illustrated in FIGS. 9A and 9B, the claws 338 and the claws 336 are arranged such that the surfaces 338a of the claws 338 face the surfaces 336a of the claws 336, and that the surfaces 338b of the claws 338 face the surfaces 336b of the claws 336. This configuration allows engagement between the claws 336 and the claws 338 when the rotating body 32 rotates in the first direction, as will be described later. When the rotating body 32 rotates in the second direction opposite to the first direction, the claws 336 receive a pressing force from the claws 338 and gradually come into the holes of the base 34 in such a manner as to escape from the claws 338 without engagement with the claws 338.

The claws 336 and the claws 338 according to this preferred embodiment correspond to the first protrusion and the second protrusion, respectively. The surfaces 336a and the surfaces 338a correspond to the second surface. The surfaces 336b and the surfaces 338b correspond to the first surface.

According to the respective preferred embodiments described herein, either the claws provided on the rotating body or the claws provided on the fan come into the corresponding holes located in the base or the rotating body. However, the claws are not required to come into the corresponding holes. For example, either the claws provided on the rotating body or the claws provided on the fan may be plate-shaped, and capable of moving only in one direction to allow and escape engagement with the other claws.

According to the respective preferred embodiments described herein, the claws fixed to the rotating body or the fan (claws not coming into holes) are constituted by protrusions (claws). However, these claws are not required to have protruding shapes, but may be constituted by recesses as long as engagement with the other claws is allowed.

The present invention is not limited to specific examples of the printers described in the first through fourth preferred embodiments of the present invention. For example, the respective preferred embodiments may be combined in appropriate manners.

For example, either the claws provided on the rotating body or the claws provided on the fan preferably are configured to come into the corresponding holes provided in the base or the rotating body according to the foregoing preferred embodiments. However, the claws are not required to come into the corresponding holes. For example, either the claws provided on the rotating body or the claws provided on the fan may be plate-shaped, and capable of moving only in one direction to allow and escape engagement with the other claws.

According to the respective preferred embodiments described herein, the claws fixed to the rotating body or the fan (claws not coming into holes) preferably are constituted by protrusions (claws). However, these claws are not required to have protruding shapes, but may be constituted by recesses as long as engagement with the other claws is allowed.

In addition, the printers in the foregoing preferred embodiments preferably block transmission of rotation from the driven pulley to the cooling assembly by the operation of the driver and the clutch. However, the transmission of rotation from the driven pulley to the cooling assembly may be blocked by another configuration which does not include the driver and the clutch. For example, a retractable shaft for connection between the driven pulley and the cooling assembly may be used. In this case, the retractable shaft is retracted from the driven pulley when a temperature detected by a temperature detector is lower than the predetermined temperature. This retraction of the retractable shaft is able to directly disconnect the driven pulley from the cooling device.

A mesh-type cover member may be attached to the discharge port, for example, to prevent entrance of foreign bodies into the housing.

The respective preferred embodiments and the modified examples described above may be combined in appropriate manners.

Preferred embodiments of the present invention are applicable to a printer which ejects ink to a medium to perform printing on the recording medium, for example.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A printer comprising:
a carriage that includes a print head from which ink is ejected to a medium;
a rotating body that rotates in a first direction based on movement of the carriage; and
a fan that rotates in the first direction by contact with a portion of the rotating body when the rotating body rotates in the first direction.

2. The printer according to claim 1, wherein
the rotating body includes a first protrusion that protrudes from a circumference of the rotating body toward the fan in a radial direction of the rotating body; and
the fan includes a second protrusion that protrudes toward the rotating body to engage with the first protrusion at a time of rotation of the rotating body in the first direction.

3. The printer according to claim 1, wherein
the fan includes a blade assembly and a base rotatable with the blade assembly;
the rotating body has a hollow and cylindrical shape;
the base has a cylindrical shape; and
the rotating body surrounds a circumference of the base.

4. The printer according to claim 1, wherein
the fan includes a blade assembly and a base rotatable with the blade assembly;
a portion of the base has a hollow and cylindrical shape;
the rotating body has a cylindrical shape; and
the base surrounds the circumference of the rotating body.

5. The printer according to claim 2, wherein one of the first protrusion and the second protrusion escapes from the other of the first protrusion and the second protrusion without engagement between the first protrusion and the second protrusion when the rotating body rotates in a second direction opposite to the first direction.

6. The printer according to claim 5, wherein
the one of the first protrusion and the second protrusion includes a surface brought into contact with the other of the first protrusion and the second protrusion when the rotating body rotates in the second direction; and
the surface is inclined relative to a surface from which the one of the first protrusion and the second protrusion protrudes, in such an inclination direction so as not to interrupt an action of the other of the first protrusion and the second protrusion.

7. The printer according to claim 5, wherein
the one of the first protrusion and the second protrusion includes a surface brought into contact with the other of the first protrusion and the second protrusion when the rotating body rotates in the first direction; and
the surface is arranged at right angles relative to a surface from which the one of the first protrusion and the second protrusion protrudes.

8. The printer according to claim 5, wherein the one of the first protrusion and the second protrusion is supported by an elastic member provided in a hole recessed in a surface from which the one of the first protrusion and the second protrusion protrudes.

9. The printer according to claim 8, wherein at a point at which the rotating body rotates in a second direction opposite to the first direction, a pressing force is exerted by a pressing member that has been pressed and is smaller than an elastic force of the elastic member.

10. The printer according to claim 1, wherein the rotating body is connected with a driven pulley that holds a belt provided to reciprocate the carriage.

11. The printer according to claim 10, further comprising a temperature detector that detects a temperature within the printer, wherein a driving force is transmitted from the driven pulley to the rotating body when the temperature detected by the temperature detector is equal to or higher than a predetermined temperature.

12. The printer according to claim 11, further comprising:
a clutch that includes a first gear connected with the driven pulley; and
a driver that drives the clutch; wherein
the clutch includes a second gear connected with the rotating body, and brought into engagement with the first gear by the driver.
